(19) United States
(12) Patent Application Publication
(10) Pub. No.: US 2025/0012665 A1
(43) Pub. Date: Jan. 9, 2025

(54) METHOD FOR TRAINING GEARBOX FAULT DIAGNOSIS MODEL, AND GEARBOX FAULT DIAGNOSIS METHOD

(71) Applicant: CHINA THREE GORGES CORPORATION, Wuhan, Hubei (CN)

(72) Inventors: Luo WANG, Wuhan, Hubei (CN); Zubing ZOU, Wuhan, Hubei (CN); Junqing LI, Wuhan, Hubei (CN); Youhan DENG, Wuhan, Hubei (CN); Zufan WANG, Wuhan, Hubei (CN); Ying SU, Wuhan, Hubei (CN)

(21) Appl. No.: 18/022,947

(22) PCT Filed: Aug. 15, 2022
(86) PCT No.: PCT/CN2022/112476

§ 371 Date: Feb. 23, 2023

(30) Foreign Application Priority Data
Mar. 15, 2022 (CN) 202210249569.6

(51) Int. Cl. G01M 13/021; G06N 3/092; G06N 5/01

(52) U.S. Cl. CPC G01M 13/021; G06N 3/092; G06N 5/01

(57) ABSTRACT

The present disclosure discloses a method for training a gearbox fault diagnosis model, and a gearbox fault diagnosis method. The method includes: acquiring a motor current signal in an electromechanical system where a gearbox is located; calculating, based on the current signal, characteristic values representing complexity and degree of mutation of the current signal; filtering the characteristic values based on a random forest algorithm to generate a sample data set; and training, based on the data set, a deep reinforcement learning network model to generate the fault diagnosis model. By means of the method for training the gearbox fault diagnosis model according to the present disclosure, merely the current signal is acquired, no additional sensor is needed, and the defect of additional hardware in the prior art is overcome.

### CROSS-REFERENCE TO RELATED APPLICATIONS

This application is a national stage application of PCT/CN2022/112476. This application claims priorities from PCT Application No. PCT/CN2022/112476, filed Aug. 15, 2022, and from the Chinese patent application 202210249569.6 filed Mar. 15, 2022, the content of which are incorporated herein in the entirety by reference.

### TECHNICAL FIELD

The present disclosure relates to the technical field of wind turbines, in particular to a method for training a gearbox fault diagnosis model, and a gearbox fault diagnosis method.

### BACKGROUND

In the process of wind power generation, due to the harsh operating environment of a wind turbine, mechanical transmission components are prone to damage. Once a gearbox as a hub is damaged, serious consequences such as shutdown of the wind turbine may be caused. Therefore, timely diagnosis of gearbox faults is helpful to reduce the operation and maintenance costs. Among current wind turbines, double-fed wind turbines are still the mainstream, and the low rotational speed of the wind turbines needs to be boosted to a high rotational speed suitable for driving a generator through a planetary gearbox. As the hub connecting the generator and a main shaft, and taking on the role of transmitting torque and boosting speed at the same time, the gearbox is an indispensable key component of the wind turbine. Local faults may occur to gears, bearings and other components during long and continuous operation of the gearbox, which, if not detected in time, may lead to aggravation of the faults and may cause the gearbox to fail and eventually shut down. The gearbox of the wind turbine is connected to the generator through the main shaft, and when the transmission system components fail, abnormal vibration may be generated, which in turn may cause fluctuations in the air-gap torque of the generator, and may eventually cause changes in a series of electrical parameters, including the stator current through stator flux. A vibration signal acquired via a vibration signal sensor is more susceptible to the interference of mechanical resonance and external noise, and a measurement result of the vibration signal is greatly affected by the location of the sensor. When local faults occur to the gearbox components, periodic pulses are generated and transmitted to a current signal via the magnetic field, so obvious periodic shocks are generated in the current signal and the signal is not smooth. As a result, fault diagnosis may be performed by measuring the complexity and the degree of mutation in effective time and frequency domain characteristic indicators of the current signal.

Most of the existing technologies use the vibration signal of the gearbox of the wind turbine for fault diagnosis, but the vibration signal obtained by the vibration signal sensor is more susceptible to the interference of mechanical resonance and external noise, and the measurement result of the vibration signal is greatly affected by the location of the sensor, so many traditional methods may not meet the requirements for high reliability and accuracy, and have the defects of low reliability, low accuracy and need for additional hardware structures.

### SUMMARY

Therefore, in order to overcome the defects of low reliability, low accuracy and need to add a hardware structure in the prior art, the present disclosure provides a method for training a gearbox fault diagnosis model, and a gearbox fault diagnosis method.

According to a first aspect, the present disclosure discloses a method for training a gearbox fault diagnosis model. The method includes: acquiring a motor current signal in an electromechanical system where a gearbox is located; calculating, based on the current signal, characteristic values representing complexity and degree of mutation of the current signal; filtering the characteristic values based on a random forest algorithm to generate a sample data set; and training, based on the sample data set, a deep reinforcement learning network model to generate the gearbox fault diagnosis model.

Optionally, the calculating, based on the current signal, characteristic values representing complexity and degree of mutation of the current signal includes: calculating, based on the current signal, fuzzy entropy characteristic values representing the complexity of the current signal; converting, on the condition that the acquired current signal is a current time domain signal, the current signal into a current frequency domain signal based on a Fourier algorithm; and calculating, based on the current time domain signal and the current frequency domain signal, time domain characteristic values and frequency domain characteristic values representing the degree of mutation, respectively.

Optionally, the filtering the characteristic values according to a random forest algorithm to generate a sample data set includes: sampling sample data including the time domain characteristic values and the frequency domain characteristic values, and generating, based on sampling results, a random forest training data set and a random forest out-of-bag data set; calculating, based on the random forest training data set and the random forest out-of-bag data set, a degree of correlation of any one of the characteristic values with a fault using the random forest algorithm; filtering, based on the degrees of correlation, the characteristic values to generate an effective characteristic data set; and generating, based on the effective characteristic data set and fuzzy entropy, the sample data set.

Optionally, the calculating, based on the random forest training data set and the random forest out-of-bag data set, a degree of correlation of any one of the characteristic values with a fault using the random forest algorithm includes: constructing, based on the random forest training data set and preset parameters of the random forest algorithm, a decision tree; inputting the random forest out-of-bag data set into the decision tree to generate a first data error; inputting the random forest out-of-bag data set into the decision tree again to generate a second data error after noise addition based on a preset interference range; and calculating, based on the first data error and the second data error, the degree of correlation of any one of the characteristic values with the fault.

Optionally, the training, based on the sample data set, a deep reinforcement learning network model to generate the gearbox fault diagnosis model includes: training, based on samples drawn from a training data set, the deep reinforcement learning network model to obtain training results, the training data set being obtained by sampling samples from the sample data set; calculating a reward value based on accuracy of the training results; determining a reward value expectation based on the reward value; and iteratively training, based on the samples drawn from the training data set, the deep reinforcement learning network model until a fluctuation of the reward value expectation is less than a preset fluctuation threshold, so as to obtain the gearbox fault diagnosis model.

Optionally, the training, based on the sample data set, a deep reinforcement learning network model to generate the gearbox fault diagnosis model further includes: inputting a test data set into the gearbox fault diagnosis model to obtain test results, the test data set including data other than the training data set in the sample data set; determining, based on accuracy of the test results, whether the gearbox fault diagnosis model is an available gearbox fault diagnosis model; and redrawing, in the case that the gearbox fault diagnosis model is an unavailable gearbox fault diagnosis model, a training data set from the sample data set to train the deep reinforcement learning network model until an available gearbox fault diagnosis model is obtained.

According to a second aspect, the present disclosure discloses a gearbox fault diagnosis method. The gearbox fault diagnosis method includes: acquiring a time series of a current signal; and inputting the time series of the current signal into the gearbox fault diagnosis model generated by the method for training the gearbox fault diagnosis model according to the first aspect and any one of the optional implementations in the first aspect, so as to obtain a gearbox fault diagnosis result.

According to a third aspect, the present disclosure discloses an apparatus for training a gearbox fault diagnosis model. The apparatus includes: a signal acquisition module, configured to acquire a motor current signal in an electromechanical system where a gearbox is located; a characteristic calculation module, configured to calculate, based on the current signal, characteristic values representing complexity and degree of mutation of the current signal; a data filtering module, configured to filter the characteristic values based on a random forest algorithm to generate a sample data set; and a model generation module, configured to train, based on the sample data set, a deep reinforcement learning network model to generate the gearbox fault diagnosis model.

According to a fourth aspect, the present disclosure discloses a gearbox fault diagnosis apparatus. The gearbox fault diagnosis apparatus includes: a data acquisition module, configured to acquire a time series of a current signal; and a fault diagnosis module, configured to input the time series of the current signal into the gearbox fault diagnosis model generated by the method for training the gearbox fault diagnosis model according to the first aspect and any one of the optional implementations in the first aspect, so as to obtain a gearbox fault diagnosis result.

According to a fifth aspect, the present disclosure discloses an electronic device. The electronic device includes: at least one processor; and a memory communicatively connected to the at least one processor, the memory having instructions executable by the at least one processor stored thereon, the instructions being executed by the at least one processor to cause the at least one processor to perform the steps of the method for training the gearbox fault diagnosis model according to the first aspect and any one of the optional implementations in the first aspect, and/or the gearbox fault diagnosis method according to the second aspect.

According to a sixth aspect, the present disclosure discloses a computer-readable storage medium, having a computer program stored thereon, the computer program, when executed by a processor, implementing the steps of the method for training the gearbox fault diagnosis model according to the first aspect and any one of the optional implementations in the first aspect, and/or the gearbox fault diagnosis method according to the second aspect.

The technical solution of the present disclosure has the following advantages
1. By means of the method for training the gearbox fault diagnosis model according to the present disclosure, only the generator current signal in the electromechanical system where the gearbox is located needs to be acquired, and no additional sensor needs to be mounted in the system. Thus, the reliability of signal acquisition is improved, equipment investment is saved, operation and maintenance costs are reduced, and the defect of need for additional hardware structures in the prior art is overcome. By calculating and filtering the characteristic values representing the complexity and degree of mutation of the current signal, the dimension of the current signal can be reduced, and fault-related characteristic data may be extracted from a large amount of information included in the current signal. By training the deep reinforcement learning network model and updating the network parameters after iterations, the gearbox fault diagnosis model that can correctly classify faults is obtained, which improves the accuracy of diagnosis and overcomes the defects of low reliability and low accuracy in the prior art.
2. By means of the method of training the gearbox fault diagnosis model according to the present disclosure, by converting the time domain signal into the frequency domain signal and deriving statistical indicators, the change of frequency band can be seen directly from frequency, and fault characteristics can be better extracted. By filtering the characteristic values based on the random forest algorithm, the precision requirements in different cases can be met by setting different numbers of decision trees. The deep reinforcement learning network model can have higher accuracy through iterative training.

### BRIEF DESCRIPTION OF THE DRAWINGS

For clearer descriptions of the technical solution of specific implementations of the present disclosure or in the related art, drawings that are to be referred for description of the specific implementations or the prior art are briefly described hereinafter. Apparently, the drawings described hereinafter illustrate some implementations of the present disclosure. Persons of ordinary skill in the art may also derive other drawings based on the drawings described herein without any creative effort.

FIG. 1 is a flow diagram of an example of a method for training a gearbox fault diagnosis model according to an embodiment of the present disclosure;

FIG. 2 is a flow diagram of another example of a method for training a gearbox fault diagnosis model according to an embodiment of the present disclosure;

FIG. 3 is a flow diagram of still another example of a method for training a gearbox fault diagnosis model according to an embodiment of the present disclosure;

FIG. 4 is a flow diagram of yet another example of a method for training a gearbox fault diagnosis model according to an embodiment of the present disclosure;

FIG. 5 is a diagram of a result of another example of a method for training a gearbox fault diagnosis model according to an embodiment of the present disclosure;

FIG. 6 is a diagram of a result of another example of a method for training a gearbox fault diagnosis model according to an embodiment of the present disclosure;

FIG. 7 is a diagram of a result of another example of a method for training a gearbox fault diagnosis model according to an embodiment of the present disclosure;

FIG. 8 is a schematic flow diagram of a gearbox fault diagnosis method according to an embodiment of the present disclosure;

FIG. 9 is a schematic block diagram of an apparatus for training a gearbox fault diagnosis model according to an embodiment of the present disclosure;

FIG. 10 is a schematic block diagram of a gearbox fault diagnosis apparatus according to an embodiment of the present disclosure; and

FIG. 11 is a schematic diagram of an electronic device according to an embodiment of the present disclosure.

### DETAILED DESCRIPTION OF THE EMBODIMENTS

The technical solutions of the present disclosure will be clearly and completely described below with reference to the accompanying drawings. Apparently, the described embodiments are a part of the embodiments of the present disclosure, rather than all the embodiments.

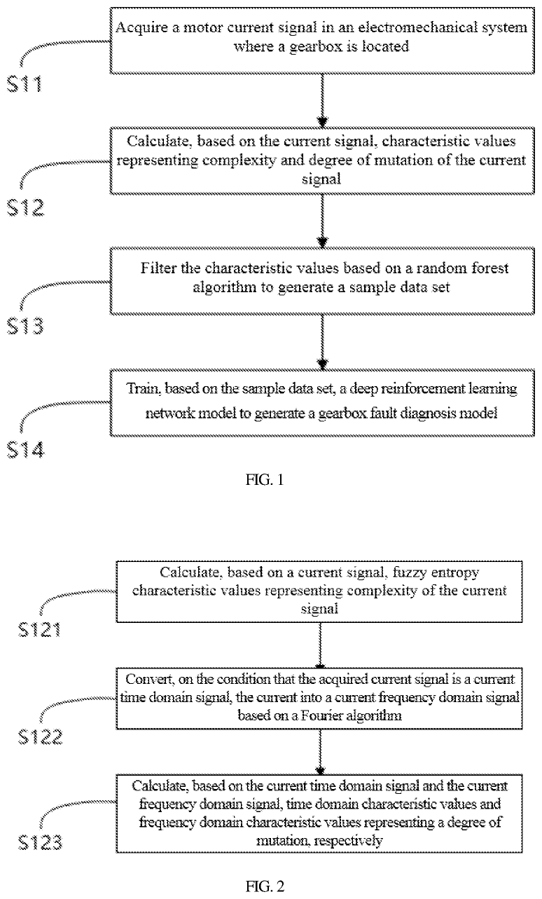

The present disclosure discloses a method for training a gearbox fault diagnosis model. As shown in FIG. 1, the method includes the following steps:
Step S11: Acquire a motor current signal in an electromechanical system where a gearbox is located.

Specifically, the motor current signal in the electromechanical system where the gearbox is located may be obtained by collecting a stator current of a motor at a certain sampling frequency through a current transformer, and the current signal obtained in this case is a time series with dimensions.

Dimension represents the number of data points in the current signal, and the number of dimensions is related to the sampling frequency and the sampling duration. The number of dimensions of the current signal may be calculated by the following equation:

N=f×t
where N is the number of dimensions, f is the sampling frequency of the current transformer, and t is the sampling duration of the current transformer.

Exemplarily, when the current transformer collects a current signal of 4 s at a sampling frequency of 64 kHz, the number of dimensions of the current signal obtained is 256,000, i.e., a total of 256,000 data points may be acquired by collecting the current signal of 4 s at the sampling frequency of 64 kHz.
Step S12: Calculate, based on the current signal, characteristic values representing complexity and a degree of mutation of the current signal.

The characteristic values representing the complexity of the current signal may be fuzzy entropy. The fuzzy entropy may measure the probability of the time series generating a new pattern, and the greater the probability of generating a new pattern, the greater the complexity of the series. When the gearbox fails, fault information may be transferred to the current signal via torque ripples, increasing the complexity of the signal. Therefore, a fault of the gearbox may be diagnosed more accurately by selecting the characteristic values representing the complexity of the signal. In particular, the characteristic values representing the complexity of the current signal may also select other parameters according to the actual situation, which is not limited by the present disclosure.

The characteristic values representing the degree of mutation of the current signal may be one or more of mean, variance, standard deviation, root mean square, skewness, kurtosis, waveform factor, crest factor, impulse factor, clearance factor, and kurtosis factor. The above indexes may change to different degrees when the gearbox fails, among which kurtosis is the most sensitive. According to the definition and calculation formulas of each characteristic quantity, for an early fault, the vibration amplitude of mechanical parts is weak and there is no excessive shock, so the root mean square may not change significantly, but dimensionless characteristic quantities, such as crest factor, impulse factor, clearance factor and kurtosis factor, may increase even under a small shock, and has strong sensitivity, while the root mean square is not sensitive to the early fault and has good stability, and may respond to serious faults. In particular, the characteristic values representing the degree of mutation of the current signal may also select other parameters according to the actual situation, which is not limited by the present disclosure.
Step S13: Filter the characteristic values based on a random forest algorithm to generate a sample data set.

Specifically, since the obtained characteristic values may include fault-unrelated data, by filtering the characteristic values based on the random forest algorithm, data with a high degree of correlation with the gearbox fault may be retained, while data with a low degree of correlation with the gearbox fault may be eliminated, which may reduce the number of characteristics, improve the accuracy of the model, and shorten the runtime.
Step S14: Train, based on the sample data set, a deep reinforcement learning network model to generate the gearbox fault diagnosis model.

Specifically, the deep reinforcement learning network model is built by combining a reinforcement learning network with a deep neural network. The model mainly includes a state space S, an action space A, a reward value R, and an agent. In particular, the sample data may be used as the state space S, and fault types may be used as the action space A. Primary rotating mechanical components in the gearbox are gears and bearings. States of the gears primarily include normal, pitting, crack and broken, etc. States of the bearings primarily include normal, inner ring pitting, inner ring plastic deformation, outer ring pitting and outer ring plastic deformation, etc. At the same time, combined faults of gears and bearings may occur. Each fault type is represented by a number to constitute the action space A. It is assumed that there are K fault types in total, that is, A=[0, 1, 2, 3, . . . , K]. The agent is formed by a deep convolutional neural network, and the deep convolutional neural network is structurally formed by an input layer, four one-dimensional convolutional layers, a flattening layer, two fully connected layers, and an output layer. For a reward mechanism, the reward +1 if the agent determines that the fault type of the sample data is correct, otherwise, the reward −1. Based on training of the sample data, the agent is made to interact with the environment, with a reward as a guide, so that the agent obtains the most rewards, and the optimal diagnosis policy is obtained.

The classification of faults via the deep convolutional neural network may be regarded as Markov decision process. For a state S, an action A is selected through a policy, the state is switched to another state S^{x} through calculation of the agent, a reward value R is returned at the same time, and the agent may adjust the policy of the decision process based on the feedback. For the action A, the value thereof is evaluated through a reward value expectation Q, and Q represents the expectation of the sum of rewards R that the agent may obtain by the final state S upon selection of the action A. In general, the reward value expectation Q needs to be updated after each training round.

Exemplarily, the process of updating the reward value expectation Q may be expressed by the following equation:

$${Q}^{\text{?}} ( S , A ) = Q ( S , A ) + α [ R + γ {max}_{\text{?}} Q ( {S}^{\text{?}} , a ) - Q ( S , A ) ]$$

$$\text{?} \text{indicates text missing or illegible when filed}$$

where Q(S, A) represents a state-action value function of the agent selecting the action A based on the policy at the state S, and the function obeys the Bellman equation; α represents the learning rate, which determines the magnitude of the update; R represents the reward of the agent when taking the action A at the current state S; a represents an action corresponding to the optimal value of the next state; and max_{α}Q(S′,α) is the optimal value of the next state S′, and R+γmax_{α}Q(S′,α) serves as the target of the update, where γ is a discount factor.

By means of the method for training the gearbox fault diagnosis model according to the present disclosure, only the motor current signal in the electromechanical system where the gearbox is located needs to be acquired, and no additional sensor needs to be mounted in the system. Thus, the reliability of signal acquisition is improved, equipment investment is saved, operation and maintenance costs are reduced, and the defect of need for additional hardware structures in the prior art is overcome. By calculating and filtering the characteristic values representing the complexity and degree of mutation of the current signal, the characteristic dimension of the current signal may be reduced, and fault-related characteristic data may be extracted from a large amount of information included in the current signal. By training the deep reinforcement learning network model and updating the network parameters after iterations, the gearbox fault diagnosis model that can correctly classify faults is obtained, which improves the accuracy of diagnosis and overcomes the defects of low reliability and low accuracy in the prior art.

As an optional implementation of the present disclosure, the calculating, based on the current signal, characteristic values representing complexity and degree of mutation of the current signal, as shown in FIG. 2, includes the following steps:
Step S121: Calculate, based on the current signal, fuzzy entropy characteristic values representing the complexity of the current signal.

Specifically, the process of calculating the fuzzy entropy characteristic values may include: first, determine the number of dimensions of a phase space and similarity tolerance based on preset rules, and reconstruct the current signal; then determine a fuzzy affiliation function based on preset rules, and calculate the similarity between two window vectors in the phase space at this time based on the fuzzy affiliation function; then calculate a data mean for each dimension of the reconstructed current signal based on the obtained similarity; calculate average similarity for the reconstructed current signal based on the data mean; and finally, calculate the fuzzy entropy based on the obtained average similarity.

For an N-dimensional current signal [u(1), u(2) . . . , u(N)], the number of dimensions m of the phase space represents the window size for dividing the time series, and needs to meet the constraints of m≤N−2, and r is the similarity tolerance, which represents similarity metric and is generally 0.2*std, where std is the standard deviation of the time series.

Exemplarily, the time series X(i) of the current signal reconstructed in the number of dimensions m of the phase space may be expressed by the following equations:

$$X ( i ) = [ u ( i ) , u ( i + 1 ) , … , u ( \text{?} + m - 1 ) ] - {u}_{0} ( i ) , i = 1 , 2 , … , N - m + 1$$

$${u}_{0} ( \text{?} ) = \frac{1}{m} {\sum }_{j = 0}^{m - 1} u ( i + j )$$

$$\text{?} \text{indicates text missing or illegible when filed}$$

where u₀(i) represents the mean of m data under a window, and i and j each represent one dimension of the reconstructed current signal.

The fuzzy affiliation function is a mathematical tool used to represent a fuzzy set, and may indicate whether elements in the set belong to a particular subset. In particular, the fuzzy affiliation function may be selected according to the actual situation, which is not limited by the present disclosure.

Exemplarily, the fuzzy affiliation function A(x) may be expressed by the following equation:

$$A ( x ) = \{ \begin{matrix}1 , & x = 0 \\ exp [ - ln ( 2 ) {( \frac{x}{r} )}^{2} ] , & x > 0\end{matrix}$$

Further, the process of calculating the similarity Aᵢⱼ^{m} between the two window vectors X(i) and X(j) in the phase space at this time according to the equation of the fuzzy affiliation function A(x) may be expressed by the following equation:

$${A}_{ij}^{m} = exp [ - ln ( 2 ) \cdot {( \frac{{d}_{ij}^{m}}{r} )}^{2} ] , j = 1 , 2 , … , N - m + 1 , and j \neq i$$

where dᵢⱼ^{m}=d[X(i),X(j)] represents an absolute distance between the window vectors X(i) and X(j).

Exemplarily, the process of calculating the data mean Cᵢ^{m}(r) for each dimension of the reconstructed current signal may be expressed by the following equation:

$${C}_{i}^{m} ( r ) = \frac{1}{N - m} {\sum }_{j = 1 , j \neq i}^{N - m + 1} {A}_{ij}^{m}$$

Exemplarily, the process of calculating the average similarity ϕ^{m}(r) for the reconstructed current signal based on the data mean may be expressed by the following equation:

$${Φ}^{m} ( r ) - \frac{1}{N - m + 1} {\sum }_{i = 1}^{N - m + 1} {C}_{i}^{m} ( r )$$

Exemplarily, the process of calculating the fuzzy entropy FuzzyEn(m,r) based on the obtained average similarity may be expressed by the following equation:

$$FuzzyEn ( m , r ) = {lim}_{N \to ∞} [ ln {Φ}^{m} ( r ) - ln {Φ}^{m + 1} ( r ) ]$$

Step S122: Convert, on the condition that the acquired current signal is a current time domain signal, the current signal into a current frequency domain signal based on a Fourier algorithm.

The current time domain signal may represent the relationship between the current signal and time, and the current frequency domain signal may represent the relationship between the current signal and frequency.

Specifically, since the acquired current signal is the time series, any data in the current signal is a current time domain signal.

Further, the Fourier algorithm may extract data of each frequency point in the current time domain signal by orthogonality, and may convert the current time domain signal into the current frequency domain signal after sorting. In particular, the process of converting the current time domain signal into the current frequency domain signal may be realized by Fourier transform algorithm, Fourier series algorithm and other methods in the prior art, which is not limited by the present disclosure.
Step S123: Calculate, based on the current time domain signal and the current frequency domain signal, time domain characteristic values and frequency domain characteristic values representing the degree of mutation, respectively.

Specifically, the characteristic values include one or more of mean, variance, standard deviation, root mean square, skewness, kurtosis, waveform factor, crest factor, impulse factor, clearance factor, and kurtosis factor. The time domain characteristic values and the frequency domain characteristic values may be obtained by substituting the current time domain signal and the current frequency domain signal into the above characteristic value equations, respectively.

The mean characteristic value x̅ may be expressed by the following equation:

$$\overline{x} = \frac{1}{n} {\sum }_{i = 1}^{n} {x}_{i}$$

where xᵢ represents each data value of the current signal, and n represents the total number of data points of the current signal.

The variance characteristic value represents the dynamic component of signal energy, which reflects the discrete degree of a signal and is a second-order center distance. The variance characteristic value σ² may be expressed by the following equation:

$${σ}^{2} = \frac{1}{n - 1} {\sum }_{i = 1}^{n} {( {x}_{i} - \overline{x} )}^{2}$$

where xᵢ represents each data value of the current signal, x̅ represents the mean characteristic value, and represents the total number of data points of the current signal.

The standard deviation characteristic value describes the magnitude of signal deviation from the mean. The standard deviation characteristic value σ may be expressed by the following equation:

$$σ = \sqrt{\frac{1}{n - 1} {\sum }_{i = 1}^{n} {( {x}_{i} - \overline{x} )}^{2}}$$

where xᵢ represents each data value of the current signal, x̅ represents the mean characteristic value, and n represents the total number of data points of the current signal.

The root mean square characteristic value is a first-order moment of a signal to represent the energy of the signal, which may reflect the impact characteristics of the signal. The root mean square characteristic value Xᵣₘₛ may be expressed by the following equation:

$${X}_{rms} = \sqrt{\frac{1}{n} \cdot {\sum }_{i = 1}^{n} {x}_{i}^{2}}$$

where xᵢ represents each data value of the current signal, and n represents the total number of data points of the current signal.

The skewness characteristic value may describe the degree of signal deviation from symmetry. The skewness characteristic value SK may be expressed by the following equation:

$$SK = \frac{1}{n} {\sum }_{i = 1}^{n} {( \vert {x}_{i} \vert - \overline{x} )}^{3}$$

where xᵢ represents each data value of the current signal, x̅ represents the mean characteristic value, and n represents the total number of data points of the current signal.

The kurtosis characteristic value may reflect distribution characteristics of random variables. The kurtosis characteristic value β may be expressed by the following equation:

$$β = \frac{1}{n} {\sum }_{i = 1}^{n} {x}_{i}^{4}$$

where xᵢ represents each data value of the current signal, and n represents the total number of data points of the current signal.

The waveform factor characteristic value is the ratio of the root mean square characteristic value to the average absolute value. The waveform factor characteristic value Cₛ may be expressed by the following equation:

$${C}_{S} = \frac{\sqrt{\frac{1}{n} \cdot {\sum }_{i = 1}^{n} {x}_{i}^{2}}}{\frac{1}{n} {\sum }_{i = 1}^{n} \vert {x}_{i} \vert}$$

where xᵢ represents each data value of the current signal, and n represents the total number of data points of the current signal.

The crest factor characteristic value is the ratio of a crest value of a signal to the root mean square characteristic value. The crest factor characteristic value C may be expressed by the following equation:

$$C = \frac{{X}_{p}}{{X}_{rms}} = \frac{max \{ \vert {x}_{i} \vert \}}{\sqrt{\frac{1}{n} \cdot {\sum }_{i = 1}^{n} {x}_{i}^{2}}}$$

where xᵢ represents each data value of the current signal, n represents the total number of data points of the current signal, Xₚ represents the maximum value of absolute values of all data points, and Xᵣₘₛ is the root mean square characteristic value.

The impulse factor characteristic value is the ratio of the crest value of the signal to the average absolute value of the signal. The impulse factor characteristic value I may be expressed by the following equation:

$$I = \frac{max \{ \vert {x}_{i} \vert \}}{\frac{1}{n} {\sum }_{i = 1}^{n} \vert {x}_{i} \vert}$$

where xᵢ represents each data value of the current signal, n represents the total number of data points of the current signal, and Xₚ represents the maximum value of absolute values of all data points.

The clearance factor characteristic value is the ratio of the crest value of the signal to the root amplitude, which may be used to detect the wear condition of a mechanical device. The clearance factor characteristic value L may be expressed by the following equation:

$$L = \frac{{X}_{p}}{{X}_{r}} = \frac{max \{ \vert {x}_{i} \vert \}}{{( \frac{1}{n} {\sum }_{i = 1}^{n} \sqrt{\vert {x}_{i} \vert} )}^{2}}$$

where xᵢ represents each data value of the current signal, n represents the total number of data points of the current signal, Xₚ represents the maximum value of absolute values of all data points, and Xᵣ represents the root amplitude of the signal.

The kurtosis factor characteristic value represents the probability of occurrence of large-amplitude pulse formed by the fault. In order to increase the gap between impulse response and background noise and thus improve the signal-to-noise ratio, the kurtosis factor characteristic value K may be expressed by the following equation:

$$K = \frac{β}{{X}_{rms}^{4}} = \frac{\frac{1}{n} {\sum }_{i = 1}^{n} {x}_{i}^{4}}{\sqrt{\frac{1}{n} \cdot {\sum }_{i = 1}^{n} {x}_{i}^{2}}}$$

where xᵢ represents each data value of the current signal, and n represents the total number of data points of the current signal.

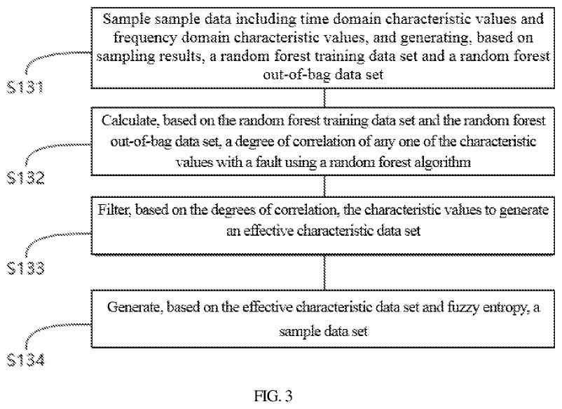

As an optional implementation of the present disclosure, the filtering the characteristic values according to a random forest algorithm to generate a sample data set, as shown in FIG. 3, includes the following steps:
Step S131: Sample sample data including the time domain characteristic values and the frequency domain characteristic values, and generating, based on sampling results, a random forest training data set and a random forest out-of-bag data set.

Specifically, for the random forest algorithm, if the size of a training set is P, P training samples are randomly drawn with replacement from the training set as a training set for each decision tree. Further, random sampling with replacement necessarily results in some data being selected and some other data not being selected, and based on sampling results, the random forest training data set is generated by the selected data, and the random forest out-of-bag data set is generated by the unselected data.

In particular, in each random sampling round, according to a probability calculation method in the prior art, about 36.8% of the samples in the training set are not sampled. That is, for the sample data including the time domain characteristic values and the frequency domain characteristic values, about 63.2% of the sample data form the random forest training data set, and about 36.8% of the sample data form the random forest out-of-bag data set.

Exemplarily, when the mean, variance, standard deviation, root mean square, skewness, kurtosis, waveform factor, crest factor, impulse factor, clearance factor, and kurtosis factor are selected as the characteristic values, the time domain characteristic values have 11 data, and the frequency domain characteristic values have 11 data, that is, 22 data are included in one sample. For 100 samples, about 63 samples in each random sampling round are used as the random forest training data set, and the other about 37 samples are the random forest out-of-bag data set.
Step S132: Calculate, based on the random forest training data set and the random forest out-of-bag data set, a degree of correlation of any one of the characteristic values with a fault using the random forest algorithm.

Specifically, the process of calculating the degree of correlation of any one of the characteristic values with the fault may include: first, construct, based on the random forest training data set and preset parameters of the random forest algorithm, a decision tree; then input the random forest out-of-bag data set into the decision tree to generate a first data error; input the random forest out-of-bag data set into the decision tree again to generate a second data error after noise addition based on a preset interference range; and calculate, based on the first data error and the second data error, the degree of correlation of any one of the characteristic values with the fault.

In particular, in the process of constructing the decision trees, the number of the decision trees also needs to be determined according to preset rules. When the number of the decision trees is large, the computation amount may be too large, and the computation time may be long. When the number of the decision trees is small, the accuracy may be reduced. Therefore, when determining the number of decision trees, it is necessary to consider the computation amount and the accuracy of random forest classification, so as to obtain the appropriate number of decision trees. The number of decision trees determines the number of sampling times, and assuming that the number of decision trees is U, sampling is performed U times to generate U sets of random forest training data sets and random forest out-of-bag data sets. Further, when the decision trees are constructed based on the preset random forest algorithm parameters, the decision trees may be constructed by inputting the random forest training data set into a preset random forest algorithm function. In particular, the process of constructing the decision trees may also be implemented in other manners in the prior art, which is not limited by the present disclosure.

The process of inputting the random forest out-of-bag data set into the decision trees to generate the first data error may be performed with out-of-bag data as input, in which case the decision trees may provide classification corresponding to the number of the out-of-bag data. Since the type of the out-of-bag data is known, the number of classification errors in the decision trees is counted by comparing correct classification with the result of the decision trees, and an out-of-bag data error is the ratio of the number of classification errors to the total number of the out-of-bag data.

Afterwards, the process of adding noise to the random forest out-of-bag data set may be performed for each value of the out-of-bag data within a preset interference range. Exemplarily, when the preset interference range is ±5, noise matching the interference range is added to each out-of-bag data to achieve noise addition to the random forest out-of-bag data set. In particular, the process of adding noise may also be implemented by using a method of extracting random values to replace original characteristics in the prior art or by disrupting the distribution of characteristic values of original samples, etc., which is not limited by the present disclosure.

Finally, the process of calculating the degree of correlation M of any one of the characteristic values with the fault may be expressed by the following equation:

$$M = \frac{1}{U} {\sum }_{i = 1}^{U} ( err {2}_{i} - err {1}_{i} )$$

where U is the number of the decision trees, err2 is the second data error, and err1 is the first data error.
Step S133: Filter, based on the degrees of correlation, the characteristic values to generate an effective characteristic data set.

Specifically, the process of filtering, based on the degrees of correlation, the characteristic values may be performed by comparing the degree of correlation M of any one of the characteristic values with a preset degree of correlation threshold M₀. If M<M₀ characteristic values are excluded, and if M>M₀ characteristic values are retained. All retained characteristic values generate the effective characteristic data set. In particular, the process of filtering, based on the degrees of correlation, the characteristic values may also select other filtering conditions according to the actual situation, which is not limited by the present disclosure.
Step S134: Generate, based on the effective feature data set and the fuzzy entropy, the sample data set.

Specifically, in the process of generating the sample data set, all data in the effective characteristic data set may be extracted and together with the fuzzy entropy, constitute the sample data set.

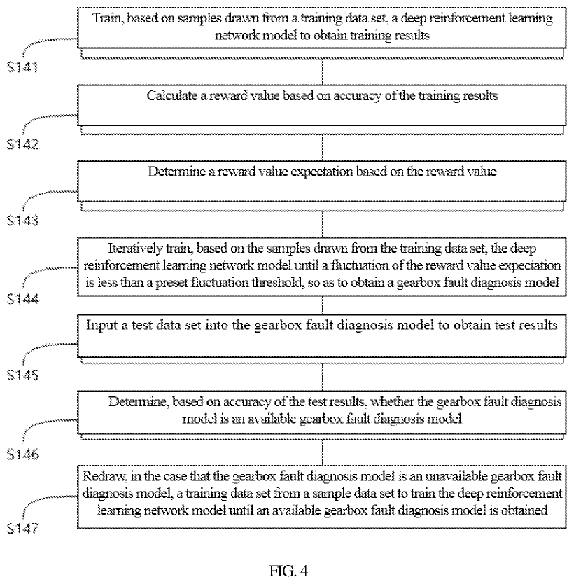

As an optional implementation of the present disclosure, the training, based on the sample data set, the deep reinforcement learning network model to generate the gearbox fault diagnosis model, as shown in FIG. 4, includes the following steps:
Step S141: Train, based on samples drawn from a training data set, the deep reinforcement learning network model to obtain training results, the training data set being obtained by sampling samples from the sample data set.

Specifically, the sample data set is first divided according to a preset ratio, and a part of the data generate the training data set. The preset ratio may be determined according to the actual situation, which is not limited by the present disclosure. In particular, the process of dividing the sample data set may be implemented by random sampling or cross validation in the prior art, which is not limited by the present disclosure.

Further, during training of the deep reinforcement learning network model, the number of training times is determined first, the corresponding number of samples are drawn from the training data set based on the number of training times, and the drawn samples are input into the deep reinforcement learning network model to constitute the state space S of the model. The more the number of training times, the higher the accuracy of the final trained deep reinforcement learning network model. In particular, the number of training times may be determined according to the actual situation, which is not limited by the present disclosure.

Specifically, the deep reinforcement learning network model, upon receiving the input sample data, may select a fault corresponding to a current sample from the pre-constructed action space A based on a preset selection policy. A greedy algorithm may be selected as the predetermined selection policy to ensure that most of faults in the action space A may be explored. In particular, the selection policy may also be implemented in other ways in the prior art, which is not limited by the present disclosure.

Further, the deep reinforcement learning network model outputs one fault for each sample drawn from the training data set as a training result, the number of training results being the same as the number of training times.
Step S142: Calculate a reward value based on accuracy of the training results.

Specifically, the reward value includes a correct reward value and an incorrect reward value. A reward value is assigned to each training result based on the accuracy of the training result, and the reward values of all training results are then summed to obtain the reward value for the current training. In particular, the correct reward value and the incorrect reward value may be selected according to the actual situation, which is not limited by the present disclosure.

Exemplarily, when the correct reward value is +1, the incorrect reward value is −1, the number of training times is 64, and a total of 55 correct results and 9 incorrect results are obtained, the reward value R may be expressed by the following equation:

$$R = 55 \times 1 + 9 \times ( - 1 ) = 46$$

Step S143: Determine a reward value expectation based on the reward value.

Specifically, based on the reward value R of the training results, the reward value expectation is updated according to a reward value expectation update equation. Since the samples in the state space S have no interrelationship, the value of the discount factor γ is 0, and the updating process of the reward value expectation may be expressed by the following equation:

Q′(S,A)=Q(S,A)+α[R−Q(S,A)]
where the learning rate α determines the update magnitude, which may be set by the actual situation and is not limited by the present disclosure. Preferably, the learning rate α may be 0.5.
Step S144: Iteratively train, based on the samples drawn from the training data set, the deep reinforcement learning network model until a fluctuation of the reward value expectation is less than a predetermined fluctuation threshold, so as to obtain the gearbox fault diagnosis model.

The process of iteratively training the deep reinforcement learning network model based on the samples drawn from the training data set includes: first, calculate a loss function for the current training round based on the reward value R of the training results and the reward value expectation Q, and then update parameters of the deep reinforcement learning network model based on the obtained loss function to achieve iterative training. Exemplarily, the loss function may be expressed using a root mean square error (RMSE) by the following equation:

$$RMSE = \sqrt{\frac{1}{m} {\sum }_{i = 1}^{m} {[ R - Q ( S , A ) ]}^{2}}$$

where m is the number of samples drawn.

Further, the process of iterative training includes: repeatedly perform steps S141 to S143 many times, i.e., draw sample data from the training data set many times, input each set of sample data into the deep reinforcement learning network model separately to obtain a plurality of reward value expectations, analyze the fluctuation between reward value expectations calculated in the last round and reward value expectations calculated in the previous round, and when the fluctuation is smaller than the preset fluctuation threshold, output the deep reinforcement learning network model at this time as the gearbox fault diagnosis model.

In particular, the process of iterative training may be stopped when the number of iterations exceeds a preset threshold for the number of iterations, so as to obtain the gearbox fault diagnosis model, or other iteration exit conditions are set, which is not limited by the present disclosure.

As an optional implementation of the present disclosure, the training, based on the sample data set, the deep reinforcement learning network model to generate the gearbox fault diagnosis model, as shown in FIG. 4, further includes:
Step S145: Input a test data set into the gearbox fault diagnosis model to obtain test results, the test data set including data other than the training data set in the sample data set.

Specifically, the data other than the training data set in the sample data set constitutes the test data set, and the data in the test data set is sequentially input into the gearbox fault diagnosis model to obtain the test results corresponding to the number of the data in the test data set.
Step S146: Determine, based on the accuracy of the test results, whether the gearbox fault diagnosis model is an available gearbox fault diagnosis model.

Specifically, the test results are compared with real results to obtain the number of correct test results, and the accuracy of the test results is the ratio of the number of the correct test results to the number of the test results. When the accuracy is greater than a preset accuracy threshold, the gearbox fault diagnosis model is determined as an available gearbox fault diagnosis model. When the accuracy is less than the preset accuracy threshold, the gearbox fault diagnosis model is determined as an unavailable gearbox fault diagnosis model.
Step S147: Redraw, in the case that the gearbox fault diagnosis model is an unavailable gearbox fault diagnosis model, a training data set from the sample data set to train the deep reinforcement learning network model until an available gearbox fault diagnosis model is obtained.

Specifically, when the gearbox fault diagnosis model is determined as an unavailable gearbox fault diagnosis model, a training data set is regenerated, and steps S141 to S145 in the method embodiment of the present disclosure are repeatedly performed to generate a new gearbox fault diagnosis model.

By means of the method of training the gearbox fault diagnosis model according to the present disclosure, by converting the time domain signal into the frequency domain signal and deriving statistical indicators, the change of frequency band can be seen directly from frequency, and fault characteristics can be better extracted. By filtering the characteristic values based on the random forest algorithm, the precision requirements in different cases can be met by setting different numbers of decision trees. The deep reinforcement learning network model can have higher accuracy through iterative training.

In one implementation, bearing faults among gearbox rotating component faults are exemplified. Based on different bearing states, 5 data sets were selected, including 1 normal state and 4 fault states. A bearing denoted as B1 was selected as the normal state, bearings denoted as B2 and B3 were selected as an inner ring fault, and bearings denoted as B4 and B5 were selected as an outer ring fault. For each state, different operating conditions were selected. A total of 20 sampling were performed for each group of experiment. During each sampling, a current signal of 4 s was collected at a sampling frequency of 64 kHz, for a total of 256,000 data.

Taking the rotational speed of 1500 rpm as an example, it may be obtained through calculation that about 2560 data points may be measured per rotation of the bearing, so 2560 was used as a window value in the data processing stage. The data of each sampling was divided into a structure of 100×2560. Since each group of experiment includes 20 sampling, the data structure after combining 20 sampling is 2000×2560, which is equivalent to converting original data into 2000 samples.

The 2560 data of the original current signal in each sample belong to the time domain, and 11 indicators including mean, variance, standard deviation, root mean square, skewness, kurtosis, waveform factor, crest factor, impulse factor, clearance factor, and kurtosis factor are calculated for each sample. The original current signal was then transformed into a frequency domain signal using Fourier decomposition, and the above 11 indicators were also calculated for the frequency domain signal. Finally, the indicators obtained in the time domain state and the frequency domain state were combined to obtain a sample of 1×22. As each group has 2000 samples, a characteristic data set with a structure of 2000×22 was finally obtained. Since the 22 indicators may have fault-unrelated characteristic quantity, the faults characteristics were filtered using the random forest algorithm. One characteristic was selected to be trained each time to obtain a correlation index M of each characteristic with the fault. If M is greater than 0, it indicates that the indicator is related to the fault.

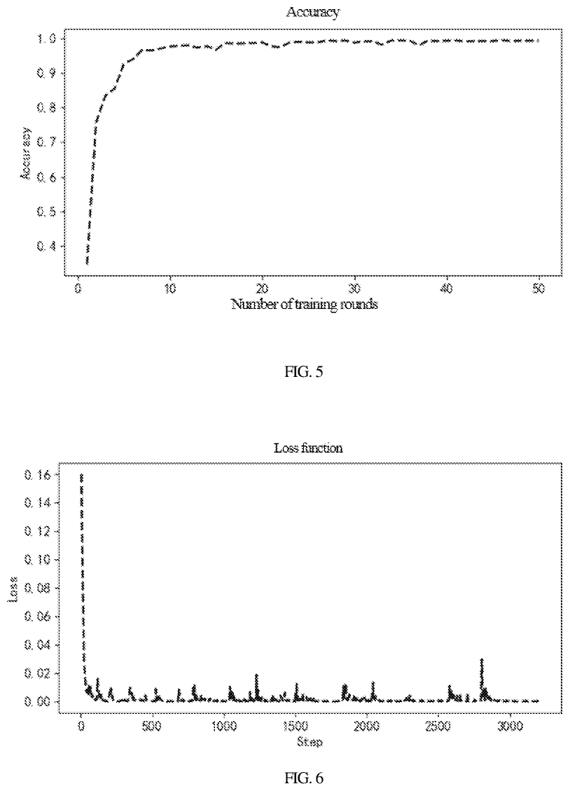

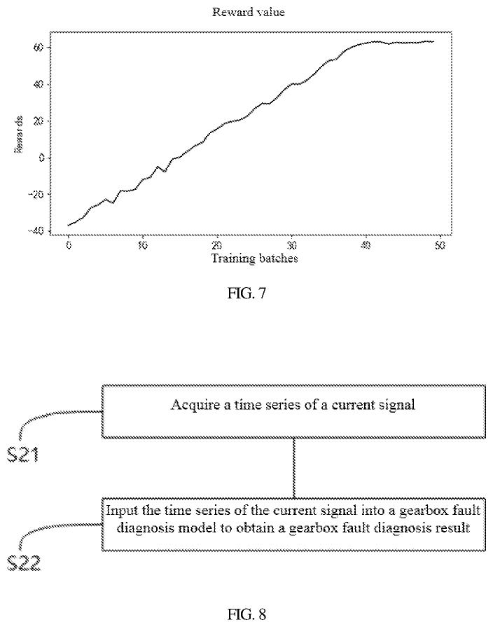

Exemplarily, when the correlation index M of each of the 22 indicators with the fault is greater than 0, it is proved that all the 22 indicators are related to the fault, so all the indicators are retained and sent to the deep reinforcement learning network model together with the fuzzy entropy. When the number of training times is 64, the training data set is generated through random sampling, and 64 samples are drawn from the training data set to train the deep reinforcement learning network model, so as to obtain 64 training results. A reward value is calculated according to the accuracy of the training results. When a preset number of iterative training rounds is 50, that is, 50 training rounds are performed, each round includes 64 times of drawing, and a reward value of each time of drawing is obtained. As shown in FIG. 5, the accuracy of the model may gradually increase with the increase of the number of iterative training rounds, and is finally stabilized at about 99%. When the number of training times is 64 and the preset number of iterative training rounds is 50, a total of 3200 samples are drawn, i.e., training is performed 3200 times in total, and the loss function of each time of training is calculated. As shown in FIG. 6, the loss rate of the model may gradually decrease with the increase of the number of iterative training rounds, and is finally stabilized at about 0.001. Every five reward values are considered as a group and averaged as a data point, and it may be seen from FIG. 7 that the reward value gradually increases with the increase of the number of learning times, and is finally stabilized at about 63, which represents that the trained model has high accuracy.

The actual accuracy of the model may be obtained by inputting a test sample into the trained gearbox fault diagnosis model and comparing the test sample with a correct result. When the actual accuracy obtained at this time is greater than the threshold, the model may be determined as an available gearbox fault diagnosis model, and the model training process is completed.

The present disclosure further discloses a gearbox fault diagnosis method. As shown in FIG. 8, the method includes the following steps:
Step S21: Acquire a time series of a current signal.

Specifically, the motor current signal in an electromechanical system where a gearbox is located may be obtained by collecting a stator current of a motor at a certain sampling frequency through a current transformer.
Step S22: Input the time series of the current signal into the gearbox fault diagnosis model generated by the method for training the gearbox fault diagnosis model according to the above embodiment, so as to obtain a gearbox fault diagnosis result.

Specifically, a sample data set is calculated based on fault-related characteristic values determined during building of the model and each data of the acquired time series of the current signal; and the sample data set is input into the gearbox fault diagnosis model to obtain the gearbox fault diagnosis result.

By means of the gearbox fault diagnosis method according to the present disclosure, only the motor current signal in the electromechanical system where the gearbox is located needs to be acquired, and no additional sensor needs to be mounted in the system. Thus, the reliability of signal acquisition is improved, equipment investment is saved, operation and maintenance costs are reduced, and the defect of need for additional hardware structures in the prior art is overcome. By inputting data into a deep reinforcement learning network model and applying machine learning technology to obtain the fault diagnosis result, the accuracy of diagnosis is improved, and the defects of low reliability and low accuracy in the prior art are overcome.

To verify the generalization capability of the gearbox fault diagnosis method according to the present disclosure, test training was performed for four operating conditions as shown in Table 1.

TABLE 1
Operating conditions

| | Radial Load | | Rotational | |
|---|---|---|---|---|
| | (N) | Torque (Nm) | Speed (rpm) | Name |
| Condition 1 | 1000 | 0.7 | 1500 | State-1 |
| Condition 2 | 1000 | 0.1 | 1500 | State-2 |
| Condition 3 | 400 | 0.7 | 1500 | State-3 |
| Condition 4 | 1000 | 0.7 | 900 | State-4 |

For the above-mentioned operating conditions, the GRU, CNN-1D and CNN-1D-GRU methods in the prior art and the gearbox fault diagnosis method according to the present disclosure were respectively used for diagnosis, and the accuracy of diagnosis results is shown in Table 2.

TABLE 2
Diagnosis results of different methods

| | Diagnosis accuracy | | | | |
|---|---|---|---|---|---|
| | of different methods | | | | Average |
| Diagnosis method | State-1 | State-2 | State-3 | State-4 | Accuracy |
| GRU | 94.39% | 97.20% | 96% | 77.96% | 91.38% |
| CNN-1D | 97.10% | 97.10% | 99.20% | 91.37% | 96.18% |
| CNN-1D-GRU | 98.60% | 96.60% | 99.50% | 90.32% | 96.25% |
| The method | 99.66% | 98.12% | 98.91% | 98.20% | 98.72% |
| according to the | | | | | |
| present disclosure | | | | | |

Based on the above comparison results, it may be concluded that the method according to the present disclosure has stable diagnosis accuracy for the four different operating conditions, exhibiting the characteristics of reinforcement learning and autonomous learning. Therefore, by performing gearbox fault diagnosis using the gearbox fault diagnosis method according to the embodiment of the present disclosure, the accuracy of fault diagnosis can be significantly improved.

The present disclosure further discloses an apparatus for training a gearbox fault diagnosis model. As shown in FIG. 9, the apparatus includes:
a signal acquisition module 101, configured to acquire a motor current signal in an electromechanical system where a gearbox is located, reference being made to the relevant content of step S11 in the method embodiment of the present disclosure for details, which will not be repeated here;
a characteristic calculation module 102, configured to calculate, based on the current signal, characteristic values representing complexity and degree of mutation of the current signal, reference being made to the relevant content of step S12 in the method embodiment of the present disclosure for details, which will not be repeated here;
a data filtering module 103, configured to filter the characteristic values based on a random forest algorithm to generate a sample data set, reference being made to the relevant content of step S13 in the method embodiment of the present disclosure for details, which will not be repeated here; and
a model generation module 104, configured to train, based on the sample data set, a deep reinforcement learning network model to generate the gearbox fault diagnosis model, reference being made to the relevant content of step S14 in the method embodiment of the present disclosure for details, which will not be repeated here.

By means of the apparatus for training the gearbox fault diagnosis model according to the present disclosure, only the motor current signal in the electromechanical system where the gearbox is located needs to be acquired, and no additional sensor needs to be mounted in the system. Thus, the reliability of signal acquisition is improved, equipment investment is saved, operation and maintenance costs are reduced, and the defect of need for additional hardware structures in the prior art is overcome. By calculating and filtering the characteristic values representing the complexity and degree of mutation of the current signal, the characteristic dimension of the current signal may be reduced, and gearbox fault-related characteristic data may be extracted from a large amount of information included in the current signal. By training the deep reinforcement learning network model and updating the network parameters after iterations, the gearbox fault diagnosis model that can correctly classify faults is obtained, which improves the accuracy of diagnosis and overcomes the defects of low reliability and low accuracy in the prior art.

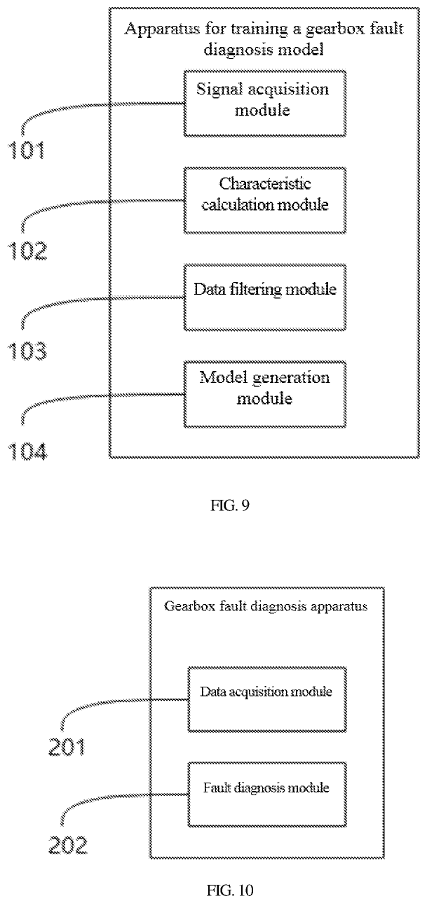

The present disclosure further discloses a gearbox fault diagnosis apparatus. As shown in FIG. 10, the apparatus includes:
a data acquisition module 201, configured to acquire a time series of a current signal, reference being made to the relevant content of step S21 in the method embodiment of the present disclosure for details, which will not be repeated here; and
a fault diagnosis module 202, configured to input the time series of the current signal into the gearbox fault diagnosis model generated by the method for training the gearbox fault diagnosis model according to any one of the embodiments of the present disclosure, so as to obtain a gearbox fault diagnosis result, reference being made to the relevant content of step S22 in the method embodiment of the present disclosure for details, which will not be repeated here.

By means of the gearbox fault diagnosis apparatus according to the embodiment of the present disclosure, only the motor current signal in an electromechanical system where a gearbox is located needs to be acquired, and no additional sensor needs to be mounted in the system. Thus, the reliability of signal acquisition is improved, equipment investment is saved, operation and maintenance costs are reduced, and the defect of need for additional hardware structures in the prior art is overcome. By inputting data into a deep reinforcement learning network model and applying machine learning technology to obtain the fault diagnosis result, the accuracy of diagnosis is improved, and the defects of low reliability and low accuracy in the prior art are overcome.

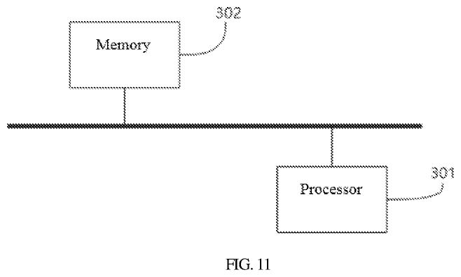

An embodiment of the present disclosure further provides an electronic device. As shown in FIG. 11, the electronic device may include a processor 301 and a memory 302. The processor 301 and the memory 302 may be connected via a bus or otherwise. The connection via a bus is exemplified in FIG. 11.

The processor 301 may be a central processing unit (CPU). The processor 301 may also be other general purpose processors, digital signal processors (DSPs), application specific integrated circuits (ASICs), field-programmable gate arrays (FPGAs) or other programmable logic devices, discrete gates or transistor logic devices, discrete hardware components and other chips, or a combination of these types of chips.

The memory 302 serves as a non-transitory computer-readable storage medium that may be configured to store non-transitory software programs, non-transitory computer executable programs, and modules, such as program instructions/modules corresponding to the method for training the gearbox fault diagnosis model and/or the gearbox fault diagnosis method according to the embodiments of the present disclosure. The processor 301 executes various functional applications of the processor as well as data processing by running the non-transitory software programs, instructions, and modules stored in the memory 302, i.e., to implement the method for training the gearbox fault diagnosis model and/or the gearbox fault diagnosis method according to the above method embodiments.

The memory 302 may include a program storage area and a data storage area. The program storage area may store applications required for an operating system and at least one function. The data storage area may store data created by the processor 301, etc. In addition, the memory 302 may include a high-speed random access memory, and may also include a non-transitory memory, such as at least one disk memory device, a flash memory device, or other non-transitory solid state memory devices. In some embodiments, the memory 302 optionally includes memories that are remotely set up relative to the processor 301, and these remote memories may be connected to the processor 301 via networks. Examples of the networks include, but are not limited to, the Internet, corporate intranets, local area networks, mobile communication networks, and combinations thereof.

One or more modules are stored in the memory 302 and, when executed by the processor 301, perform the method for training the gearbox fault diagnosis model and/or the gearbox fault diagnosis method as the embodiment shown in FIG. 1 and/or FIG. 5.

1. A method for training a gearbox fault diagnosis model, comprising:
acquiring a motor current signal in an electromechanical system where a gearbox is located;
calculating, based on the current signal, characteristic values representing complexity and degree of mutation of the current signal;
filtering the characteristic values based on a random forest algorithm to generate a sample data set; and
training, based on the sample data set, a deep reinforcement learning network model to generate the gearbox fault diagnosis model, wherein
the calculating, based on the current signal, characteristic values representing complexity and degree of mutation of the current signal comprises:
calculating, based on the current signal, fuzzy entropy characteristic values representing the complexity of the current signal;
converting, on the condition that the acquired current signal is a current time domain signal, the current signal into a current frequency domain signal based on a Fourier algorithm; and
calculating, based on the current time domain signal and the current frequency domain signal, time domain characteristic values and frequency domain characteristic values representing the degree of mutation, respectively;
the filtering the characteristic values according to a random forest algorithm to generate a sample data set comprises:
sampling sample data comprising the time domain characteristic values and the frequency domain characteristic values, and generating, based on sampling results, a random forest training data set and a random forest out-of-bag data set;
calculating, based on the random forest training data set and the random forest out-of-bag data set, a degree of correlation of any one of the characteristic values with a fault using the random forest algorithm;
filtering, based on the degrees of correlation, the characteristic values to generate an effective characteristic data set; and
generating, based on the effective characteristic data set and fuzzy entropy, the sample data set;
the calculating, based on the random forest training data set and the random forest out-of-bag data set, a degree of correlation of any one of the characteristic values with a fault using the random forest algorithm comprises:
constructing, based on the random forest training data set and preset parameters of the random forest algorithm, a decision tree;
inputting the random forest out-of-bag data set into the decision tree to generate a first data error;
inputting the random forest out-of-bag data set into the decision tree again to generate a second data error after noise addition based on a preset interference range; and
calculating, based on the first data error and the second data error, the degree of correlation of any one of the characteristic values with the fault; and
the training, based on the sample data set, a deep reinforcement learning network model to generate the gearbox fault diagnosis model comprises:
training, based on samples drawn from a training data set, the deep reinforcement learning network model to obtain training results, the training data set being obtained by sampling samples from the sample data set;
calculating a reward value based on accuracy of the training results;
determining a reward value expectation based on the reward value; and
iteratively training, based on the samples drawn from the training data set, the deep reinforcement learning network model until a fluctuation of the reward value expectation is less than a preset fluctuation threshold, so as to obtain the gearbox fault diagnosis model.

2. The method for training a gearbox fault diagnosis model according to claim 1, wherein the training, based on the sample data set, a deep reinforcement learning network model to generate the gearbox fault diagnosis model further comprises:
inputting a test data set into the gearbox fault diagnosis model to obtain test results, the test data set comprising data other than the training data set in the sample data set;
determining, based on accuracy of the test results, whether the gearbox fault diagnosis model is an available gearbox fault diagnosis model; and
redrawing, in the case that the gearbox fault diagnosis model is an unavailable gearbox fault diagnosis model, a training data set from the sample data set to train the deep reinforcement learning network model until an available gearbox fault diagnosis model is obtained.

3. (canceled)

4. An apparatus for training a gearbox fault diagnosis model, comprising:
a signal acquisition module, configured to acquire a motor current signal in an electromechanical system where a gearbox is located;
a characteristic calculation module, configured to calculate, based on the current signal, characteristic values representing complexity and degree of mutation of the current signal;
a data filtering module, configured to filter the characteristic values based on a random forest algorithm to generate a sample data set; and
a model generation module, configured to train, based on the sample data set, a deep reinforcement learning network model to generate the gearbox fault diagnosis model, wherein
the calculating, based on the current signal, characteristic values representing complexity and degree of mutation of the current signal comprises: calculating, based on the current signal, fuzzy entropy characteristic values representing the complexity of the current signal; converting, on the condition that the acquired current signal is a current time domain signal, the current signal into a current frequency domain signal based on a Fourier algorithm; and calculating, based on the current time domain signal and the current frequency domain signal, time domain characteristic values and frequency domain characteristic values representing the degree of mutation, respectively;
the filtering the characteristic values according to a random forest algorithm to generate a sample data set comprises: sampling sample data comprising the time domain characteristic values and the frequency domain characteristic values, and generating, based on sampling results, a random forest training data set and a random forest out-of-bag data set; calculating, based on the random forest training data set and the random forest out-of-bag data set, a degree of correlation of any one of the characteristic values with a fault using the random forest algorithm; filtering, based on the degrees of correlation, the characteristic values to generate an effective characteristic data set; and generating, based on the effective characteristic data set and a fuzzy entropy, the sample data set;
the calculating, based on the random forest training data set and the random forest out-of-bag data set, a degree of correlation of any one of the characteristic values with a fault using the random forest algorithm comprises: constructing, based on the random forest training data set and preset parameters of the random forest algorithm, a decision tree; inputting the random forest out-of-bag data set into the decision tree to generate a first data error; inputting the random forest out-of-bag data set into the decision tree again to generate a second data error after noise addition based on a preset interference range; and calculating, based on the first data error and the second data error, the degree of correlation of any one of the characteristic values with the fault; and
the training, based on the sample data set, a deep reinforcement learning network model to generate the gearbox fault diagnosis model comprises: training, based on samples drawn from a training data set, the deep reinforcement learning network model to obtain training results, the training data set being obtained by sampling samples from the sample data set; calculating a reward value based on accuracy of the training results; determining a reward value expectation based on the reward value; and iteratively training, based on the samples drawn from the training data set, the deep reinforcement learning network model until a fluctuation of the reward value expectation is less than a preset fluctuation threshold, so as to obtain the gearbox fault diagnosis model.

5. An electronic device, comprising: at least one processor; and a memory communicatively connected to the at least one processor, the memory having instructions executable by the at least one processor stored thereon, the instructions being executed by the at least one processor to cause the at least one processor to perform the steps of the method for training the gearbox fault diagnosis model according to claim 1.

6. A computer-readable storage medium, having a computer program stored thereon, the computer program, when executed by a processor, is configured to perform the following steps:
acquiring a motor current signal in an electromechanical system where a gearbox is located;
calculating, based on the current signal, characteristic values representing complexity and degree of mutation of the current signal;
filtering the characteristic values based on a random forest algorithm to generate a sample data set; and
training, based on the sample data set, a deep reinforcement learning network model to generate the gearbox fault diagnosis model, wherein
the calculating, based on the current signal, characteristic values representing complexity and degree of mutation of the current signal comprises:
calculating, based on the current signal, fuzzy entropy characteristic values representing the complexity of the current signal;
converting, on the condition that the acquired current signal is a current time domain signal, the current signal into a current frequency domain signal based on a Fourier algorithm; and
calculating, based on the current time domain signal and the current frequency domain signal, time domain characteristic values and frequency domain characteristic values representing the degree of mutation, respectively;
the filtering the characteristic values according to a random forest algorithm to generate a sample data set comprises:
sampling sample data comprising the time domain characteristic values and the frequency domain characteristic values, and generating, based on sampling results, a random forest training data set and a random forest out-of-bag data set;
calculating, based on the random forest training data set and the random forest out-of-bag data set, a degree of correlation of any one of the characteristic values with a fault using the random forest algorithm;
filtering, based on the degrees of correlation, the characteristic values to generate an effective characteristic data set; and
generating, based on the effective characteristic data set and fuzzy entropy, the sample data set;
the calculating, based on the random forest training data set and the random forest out-of-bag data set, a degree of correlation of any one of the characteristic values with a fault using the random forest algorithm comprises:
constructing, based on the random forest training data set and preset parameters of the random forest algorithm, a decision tree;
inputting the random forest out-of-bag data set into the decision tree to generate a first data error;
inputting the random forest out-of-bag data set into the decision tree again to generate a second data error after noise addition based on a preset interference range; and
calculating, based on the first data error and the second data error, the degree of correlation of any one of the characteristic values with the fault; and
the training, based on the sample data set, a deep reinforcement learning network model to generate the gearbox fault diagnosis model comprises:
training, based on samples drawn from a training data set, the deep reinforcement learning network model to obtain training results, the training data set being obtained by sampling samples from the sample data set;
calculating a reward value based on accuracy of the training results;
determining a reward value expectation based on the reward value; and
iteratively training, based on the samples drawn from the training data set, the deep reinforcement learning network model until a fluctuation of the reward value expectation is less than a preset fluctuation threshold, so as to obtain the gearbox fault diagnosis model.

7. The electronic device according to claim 5, wherein the training, based on the sample data set, a deep reinforcement learning network model to generate the gearbox fault diagnosis model further comprises:
inputting a test data set into the gearbox fault diagnosis model to obtain test results, the test data set comprising data other than the training data set in the sample data set;
determining, based on accuracy of the test results, whether the gearbox fault diagnosis model is an available gearbox fault diagnosis model; and
redrawing, in the case that the gearbox fault diagnosis model is an unavailable gearbox fault diagnosis model, a training data set from the sample data set to train the deep reinforcement learning network model until an available gearbox fault diagnosis model is obtained.

8. The computer-readable storage medium according to claim 6, wherein the training, based on the sample data set, a deep reinforcement learning network model to generate the gearbox fault diagnosis model further comprises:
inputting a test data set into the gearbox fault diagnosis model to obtain test results, the test data set comprising data other than the training data set in the sample data set;
determining, based on accuracy of the test results, whether the gearbox fault diagnosis model is an available gearbox fault diagnosis model; and
redrawing, in the case that the gearbox fault diagnosis model is an unavailable gearbox fault diagnosis model, a training data set from the sample data set to train the deep reinforcement learning network model until an available gearbox fault diagnosis model is obtained.
